(19) United States
(12) Patent Application Publication
(10) Pub. No.: US 2024/0383814 A1
(43) Pub. Date: Nov. 21, 2024

(54) CHEMICAL MODIFIER FOR PbZrO3-BASED ANTIFERROELECTRIC CERAMICS TO REDUCE FABRICATION TEMPERATURE AND IMPROVE DIELECTRIC BREAKDOWN STRENGTH

(71) Applicant: Iowa State University Research Foundation, Inc., Ames, IA (US)

(72) Inventors: Xiaoli Tan, Ames, IA (US); Binzhi Liu, Columbus, OH (US); Anand Prakash Singh Gaur, Ames, IA (US); Jun Cui, Ames, IA (US)

(21) Appl. No.: 18/656,904

(22) Filed: May 7, 2024

Related U.S. Application Data
(60) Provisional application No. 63/503,302, filed on May 19, 2023.

(51) Int. Cl. C04B 35/48; C04B 35/64; H01G 4/12; H01G 4/30

(52) U.S. Cl. CPC C04B 35/48; C04B 35/64; H01G 4/1236; H01G 4/30; C04B 2235/3201; C04B 2235/3248; C04B 2235/3296; C04B 2235/3298; C04B 2235/77; C04B 2235/786

(57) ABSTRACT

A lead zirconate-based antiferroelectric material is provided that includes lithium and bismuth substitutions for lead on the perovskite crystal structure. The lithium and bismuth are provided at an atomic ratio of 1:1, and the lead may substituted with lithium and bismuth up to 16 at %. The modified composition provides increased energy efficiency, increased dielectric breakdown strength, and lower sintering temperature. The modified composition is suitable for use as a capacitor having high power density and energy density.

### CROSS-REFERENCE TO RELATED PATENT APPLICATIONS

This patent application claims the benefit of U.S. Provisional Patent Application No. 63/503,302, filed May 19, 2023.

### STATEMENT REGARDING FEDERALLY SPONSORED RESEARCH AND DEVELOPMENT

This invention was made in part with Government support under Contract Number DE-EE0009105 awarded by the Department of Energy. The Government has certain rights in the invention.

### FIELD OF THE INVENTION

This invention generally relates to a ceramic material usable in a capacitor and, in particular, to an antiferroelectric ceramic material for a capacitor having improved energy efficiency and increased dielectric breakdown strength.

### BACKGROUND OF THE INVENTION

Capacitors are ubiquitous in modern electronics for both industrial and consumer applications. For instance, some smartphone designs incorporate more than 700 capacitors. Ceramic capacitors account for about 90% of the capacitor market by volume, with more than two trillion multilayer ceramic capacitors (MLCC) manufactured each year. High energy density capacitors are urgently needed in such areas as the storage of electricity generated from renewable sources and power electronics for the electric grid and in electric cars. As an example, of all the components used in power conditioning modules, capacitors take up the largest volume and contribute the greatest weight.

Ferroelectrics are extensively used in capacitors, particularly in the form of MLCCs. As one of the most heavily studied ferroelectrics, BaTiO₃-based ceramic is the MLCC industry standard because of its high dielectric constant. However, despite possessing a comparatively high power density, ferroelectric materials have a comparatively low energy density compared to other energy storage devices, such as batteries and fuel cells. Thus, a capacitor able to provide a higher energy density while maintaining a high power density is desirable, particularly for such applications as electric vehicle charging and in windmills.

### BRIEF SUMMARY OF THE INVENTION

Embodiments of the disclosure relate to an improved ceramic material that is particularly suitable for use in a capacitor. In particular, the ceramic material is antiferroelectric (AFE) and provides enhanced energy efficiency and increased dielectric breakdown strength compared to conventional AFE ceramics. In this way, the disclosed AFE ceramic can be used in capacitors to replace traditional ferroelectric ceramic materials, thereby providing higher energy density while maintaining a high power density.

As will be described more fully below, the energy efficiency (η) of such AFE capacitors is 90% or higher, in particular 94% or higher. Further, the energy density (W_{rec}) is at least 3.0 J/cm³. In this way, high energy-density capacitors with high efficiency can be produced at large scale using current MLCC technologies.

As such, AFE ceramic materials can replace current linear or ferroelectric ceramics as the dielectric layer in capacitors, improving the energy storage density by more than 10-fold. AFE capacitors maintain the high power density of current dielectric capacitors, allowing the AFE capacitors to release stored electric energy at least 100× faster than electrochemical devices, such as batteries and hydrogen fuel cells. Moreover, it is believed that the disclosed AFE ceramic material could also have applications in other contexts, including as an electrocaloric medium for dielectric refrigeration and as an active material in large stroke actuators.

In a first aspect, embodiments of the disclosure relate to an antiferroelectric material. The antiferroelectric material is made from a PbZrO₃-based ceramic in which at least 1 at % and up to 16 at % of Pb is substituted with a combination of Li and Bi.

In a second aspect, embodiments of the disclosure relate to an antiferroelectric material according to the first aspect in which a ratio of Li to Bi is about 1:1.

In a third aspect, embodiments of the disclosure relate to an antiferroelectric material according to the first aspect or the second aspect in which the antiferroelectric material has an energy density of at least 3.0 J/cm².

In a fourth aspect, embodiments of the disclosure relate to an antiferroelectric material according to any of the first aspect to the third aspect in which the antiferroelectric material has an energy efficiency of at least 90%.

In a fifth aspect, embodiments of the disclosure relate to an antiferroelectric material according to any of the first aspect to the fourth aspect in which the antiferroelectric material has a general formula of [Pb_{1-x-y-z-1.5w}(Li_{1/2}Bi_{1/2})ₓSr_{y}Ba_{z}La_{w}](Zr₁₋ᵤ₋ᵥSnᵤTiᵥ)O₃.

In a sixth aspect, embodiments of the disclosure relate to an antiferroelectric material according to the fifth aspect in which 0.01≤x≤0.12.

In a seventh aspect, embodiments of the disclosure relate to an antiferroelectric material according to the fifth aspect or the sixth aspect in which 1-x-y-z-1.5w≥0.85.

In an eighth aspect, embodiments of the disclosure relate to an antiferroelectric material according to any of the fifth aspect to the seventh aspect in which 1-u-v≥0.50.

In a ninth aspect, embodiments of the disclosure relate to an antiferroelectric material according to any of the fifth aspect to the eighth aspect in which v≤0.12.

In a tenth aspect, embodiments of the disclosure relate to an antiferroelectric material according to any of the first aspect to the ninth aspect in which the antiferroelectric material has an average grain size of 3 μm or less.

In an eleventh aspect, embodiments of the disclosure relate to an antiferroelectric material according to any of the first aspect to the tenth aspect in which the antiferroelectric material has a dielectric breakdown strength of 180 kV/cm or higher.

In a twelfth aspect, embodiments of the disclosure relate to an antiferroelectric material according to any of the first aspect to the eleventh aspect in which a temperature at which a maximum dielectric constant is reached is at least 140° C.

In a thirteenth aspect, embodiments of the disclosure relate to a capacitor including the antiferroelectric material according to any of the first aspect to the twelfth aspect.

In a fourteenth aspect, embodiments of the disclosure relate to the capacitor according to the thirteenth aspect in which the capacitor is a multilayer ceramic capacitor.

In a fifteenth aspect, embodiments of the disclosure relate to a method of preparing an antiferroelectric material made of a PbZrO₃-based ceramic in which at least 1 at % and up to 16 at % of Pb is substituted with Li and Bi. In the method, a plurality of powdered raw materials is mixed. The plurality of powdered raw materials includes cations of lead, zirconium, lithium, and bismuth. The plurality of powdered raw materials is sintered at a temperature of 1300° C. or less to form the antiferroelectric material.

In a sixteenth aspect, embodiments of the present disclosure relate to the method according to the fifteenth aspect in which mixing further involves mixing the plurality of powdered ceramics with a binder. The method further includes pressing the plurality of powdered raw materials into a green body and heating the green body to a temperature sufficient to burn off the binder. Sintering further involves sintering the plurality of powdered ceramics in the green body.

In a seventeenth aspect, embodiments of the present disclosure relate to the method of the fifteenth aspect or the sixteenth aspect in which the plurality of powdered raw materials includes PbO, Li₂CO₃, Bi₂O₃, ZrO₂, and at least two of La₂O₃, SrCO₃, SnO₂, or BaO.

In an eighteenth aspect, embodiments of the present disclosure relate to the method of the seventeenth aspect in which excess PbO powder is provided to account for evaporation during sintering.

In a nineteenth aspect, embodiments of the present disclosure relate to the method of any of the fifteenth aspect to the eighteenth aspect in which the antiferroelectric material has a density of at least 95% after sintering.

In a twentieth aspect, embodiments of the present disclosure relate to the method of any of the fifteenth aspect to the nineteenth aspect in which the temperature during sintering is 1100° C. or less.

These and other advantages of the invention, as well as additional inventive features, will be apparent from the description of the invention provided herein.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts a graph of polarization vs. electric field for an antiferroelectric material, including characteristic double hysteresis loop, according to an example;

FIG. 2 depicts a graph of polarization vs. electric field for an antiferroelectric capacitor, highlighting the charging and discharging portions of the cycle, according to an example;

FIG. 3 depicts graphs of polarization vs. electric field for a linear dielectric, a ferroelectric material, a relaxor material, and an antiferroelectric material, according to an example;

FIGS. 4A and 4B depict a strategy for improving the energy efficiency and energy density of an antiferroelectric material, according to embodiments of the present disclosure;

FIG. 5 depicts examples the perovskite crystal structure of an antiferroelectric material, according to embodiments of the present disclosure;

FIGS. 6A and 6B depict X-ray diffraction data for PbZrO₃-based antiferroelectric materials having Li and Bi substituted for Pb in various amounts, according to embodiments of the present disclosure;

FIGS. 7A-7E provide scanning electron microscopy (SEM) micrographs of the PbZrO₃-based antiferroelectric materials of FIGS. 6A and 6B, according to embodiments of the present disclosure;

FIG. 8 is a graph of grain size and sintering temperature for the PbZrO₃-based antiferroelectric materials of FIG. 6, according to embodiments of the present disclosure;

FIG. 9 provides graphs of dielectric constant and loss tangent as a function of temperature for the PbZrO₃-based antiferroelectric materials of FIG. 6, according to embodiments of the present disclosure;

FIG. 10 provides graphs of polarization as a function of electric field for the PbZrO₃-based antiferroelectric materials of FIG. 6, according to embodiments of the present disclosure;

FIG. 11 is a Weibull analysis of the dielectric breakdown strength of the PbZrO₃-based antiferroelectric materials according to embodiments of the present disclosure as compared to a conventional antiferroelectric material;

FIGS. 12A-12C depict P-E loops for samples of an antiferroelectric material having the formula of [Pb_{0.87-x}(Li_{1/2}Bi_{1/2})ₓBa_{0.05}Sr_{0.05}La_{0.02})](Zr_{0.52}Sn_{0.40}Ti_{0.08})O₃ in which x is 0.04, 0.06, and 0.08, respectively;

FIG. 13 provide an X-ray diffraction spectra for the samples prepared as described in relation to FIGS. 12A-12C;

FIG. 14 is a Weibull analysis of the dielectric breakdown strength of the samples prepared as described in relation to FIGS. 12A-12C; and

FIG. 15 is a schematic depiction of a capacitor incorporating an antiferroelectric ceramic material, according to embodiments of the present disclosure.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Reference will now be made in detail to various embodiments of an antiferroelectric (AFE) ceramic material having an improved dielectric breakdown strength, improved energy efficiency, and decreased sintering temperature. According to the present disclosure, the AFE ceramic material is based on lead zirconate (PbZrO₃) in which lead is substituted with lithium (Li) and bismuth (Bi). In one or more embodiments, the lead may also be substituted with strontium (Sr), lanthanum (La), and barium (Ba), and the zirconium (Zr) may be substituted with tin (Sn) and titanium (Ti). The AFE ceramic material according to the present disclosure can be used in capacitors, particularly capacitors for power electronics of electric vehicles and windmills.

Advantageously, the disclosed AFE ceramic material has an increased energy density of 3.0 J/cm³ or greater and an energy efficiency of over 90%. Conventionally, AFE ceramic materials have been limited to energy densities of about 2 J/cm³ and an energy efficiency of about 70%. In addition to the improved performance, the disclosed composition of the AFE ceramic material also provides the advantage of a lower sintering temperature, which decreases energy consumption and costs associated with fabrication.

These and other aspects and advantages will be described more fully below in relation to the disclosed embodiments, and such embodiments are presented by way of illustration and not by way of limitation.

AFE materials have the potential for use in many different applications, and many uses of AFE materials take advantage of the AFE-to-ferroelectric (FE) phase transition, where certain properties abruptly change at the FE critical field (E_{F}) and the AFE critical field (E_{A}). At the transition field, conventional AFE materials have a large AFE/FE phase incompatibility, and a large hysteresis is formed, causing a large strain. In certain applications, the strain is advantageous for use in actuators, transducers, shape memory devices, etc. However, the large hysteresis is disadvantageous for capacitor applications because the large hysteresis decreases energy efficiency (causing energy to dissipate through heat) and decreases the number of cycles for capacitor lifetime.

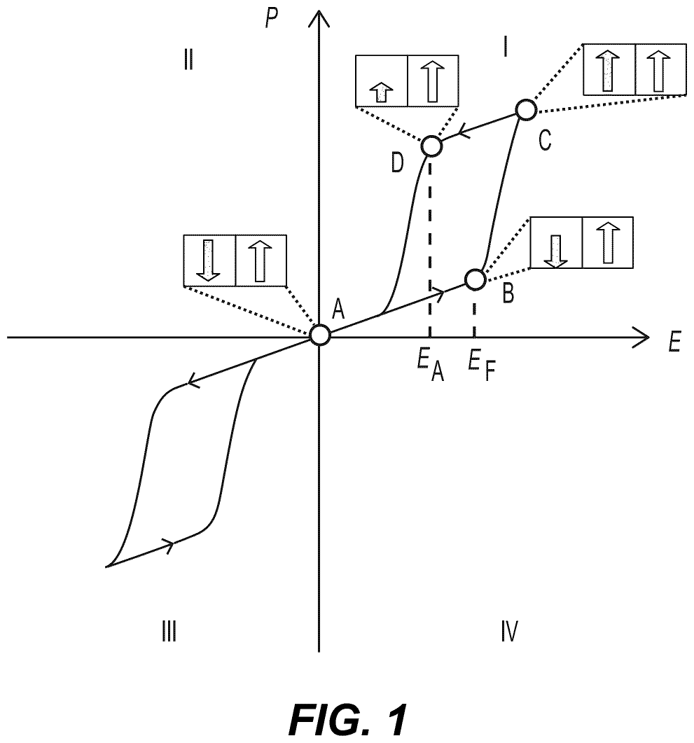

In a crystal of an AFE ceramic, the polarization is in such a manner that neighboring ions are polarized into the antiparallel direction resulting in zero macroscopic polarization. In many AFE ceramic materials, when an external stimulus, such as an electric field, is applied, the antiparallel polarization can be aligned to a long-range polar order, which leads to the field-induced AFE/FE phase transition and the peculiar signature of the AFE, which is a double hysteresis loop as shown in FIG. 1. In particular, the hysteresis loops can be seen in quadrants I and III of the graph of electric field (E) vs. polarization (P) of FIG. 1.

From FIG. 1, it can be seen that, starting at Point A, the AFE material exhibits a linear dielectric behavior (Point A to Point B) at the beginning of the AFE/FE transition in which antiparallel polarization starts to align to the external field direction. Point B (E_{F}) is the beginning of the AFE-to-FE transition. From Point B to Point C, most polarizations are flipped to the electric field direction, and the material becomes FE at Point C. When the driving force is unloaded, the flipped polarization vectors gradually decrease the magnitude. At Point D (E_{A}), the FE/AFE phase transition is initiated and eventually transits back to Point A. When the electric field is negative, the loop is inversed in the third quadrant (III), and therefore the double hysteresis loop is observed. For an ideal AFE material, after retracting the electric field the remnant polarization will be zero because only the non-polar AFE phase exists at the zero field. The double hysteresis loop originates from the free energy of the AFE being slightly lower than that of the FE.

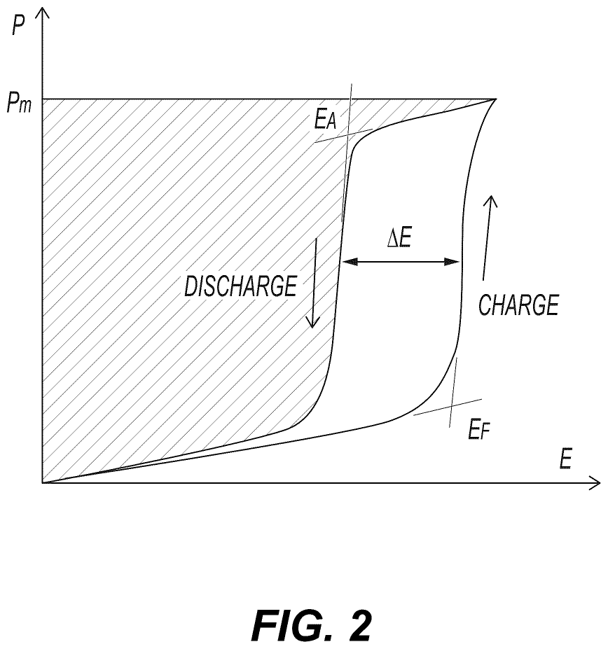

In a capacitor, the working mechanism of an AFE ceramic material is through a diffusionless, displacive phase transition. FIG. 2 depicts the charging/discharging cycle of a capacitor containing an AFE ceramic material. Upon charging, the AFE dielectric transforms to a FE phase at the critical field E_{F}, and during discharging, the reverse transition occurs at the different critical field E_{A}. The shaded area represents the energy density (W_{rec}) that is recovered during discharging. In current AFE ceramic materials, around 30% of the stored energy (Wₛₜ) is lost as a result of the phase transition hysteresis ΔE. According to the present disclosure, a higher energy density is obtained by increasing both E_{A} and E_{F} as well as by increasing the electric polarization at peak field, Pₘ.

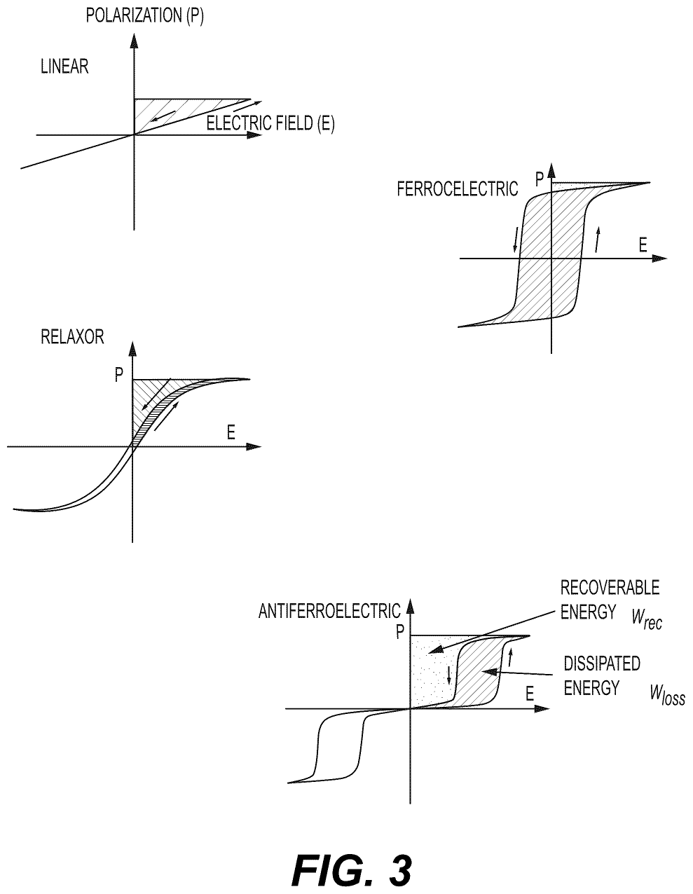

FIG. 3 depicts example of polarization vs. electric field curves for four different types of materials: a linear dielectric material, an FE material, a relaxor material, and an AFE material. The shaded area to the left of each curve represents the recoverable energy from the polarization of the material in response to the application of an electric field. As can be seen, the linear dielectric and the relaxor material allow for a significant fraction of stored energy to be released during discharging. However, the FE material, as discussed above, has a low energy density (small area to the left of the curve in quadrant I). Conventional AFE materials have a wide hysteresis loop, providing enhanced recoverable energy but also large energy losses (area within the hysteresis loop).

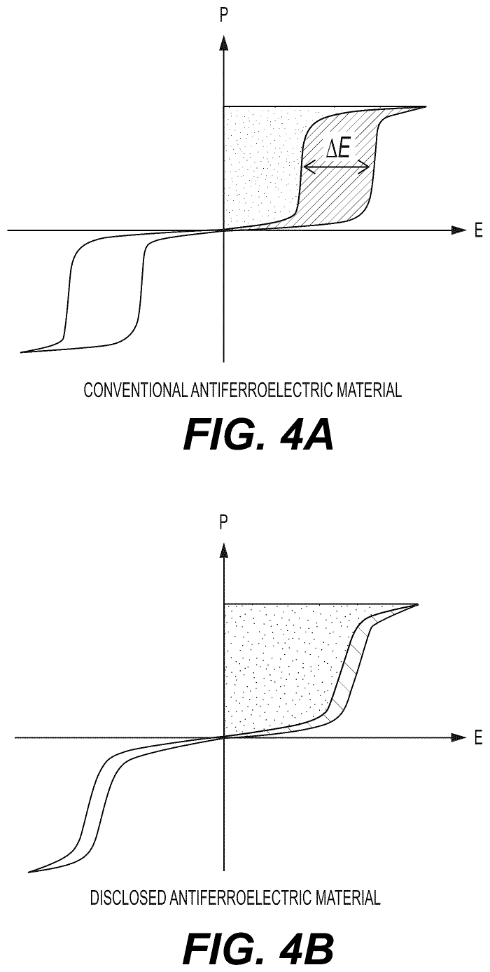

Typically, a relaxor material has complicated compositions with multiple cations of different valences sharing the same lattice site. The random occupancy of these cations in the lattices disrupts the long-range ferroelectric order, which creates easily polarized polar nanoregions, leading to a nearly zero electric hysteresis. Based on this phenomenon, the inventors propose a “relaxor AFE” material as shown in FIG. 4B. In particular, FIG. 4A depicts a conventional AFE material having a wide hysteresis loop (large ΔE=E_{F}−E_{A}), and as will be described below, the composition of the disclosed AFE ceramic material is modified to decrease ΔE so that the double hysteresis loop resembles a relaxor material curve. Specifically, the modification of the composition seeks to disrupt the AFE long-range order, resulting in the formation of the AFE nanoclusters, and therefore, the antiparallel cation displacement can be flipped easier with reduced hysteresis. Furthermore, A-site vacancies (discussed below) can also enhance the relaxor behavior.

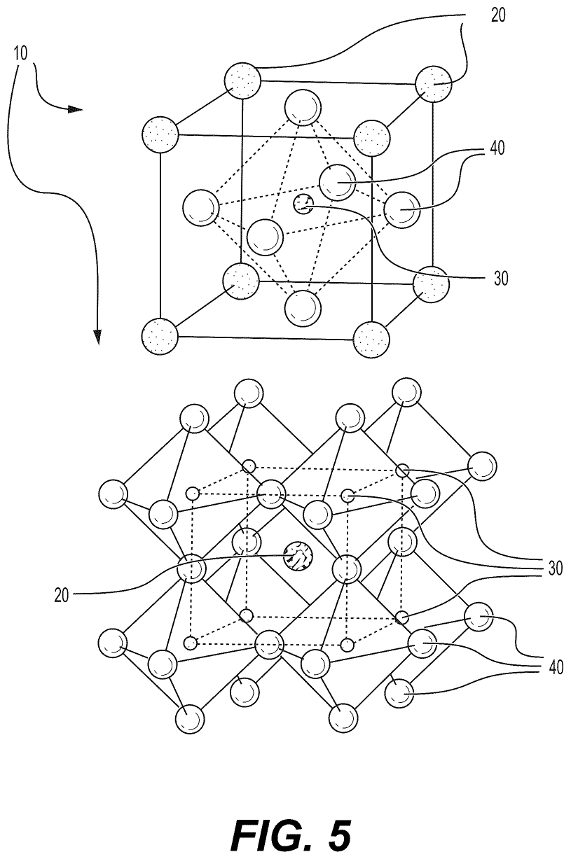

According to the present disclosure, the AFE ceramic material is based on PbZrO₃, which is a perovskite compound. The perovskite structure 10 can be represented as shown in FIG. 5. With respect to the upper representation of the perovskite crystal 10, A-site cations 20 are situated in the corners. Usually, the A-site cations 20 are large and can be monovalent, divalent, and trivalent atoms. Smaller B-site cations 30 are in the cubic centers. The B-site cations 30 can be trivalent, tetravalent, and pentavalent elements. The face centers 40 of the unit cells are occupied by oxygen. The coordination numbers of A-site cations 20 and B-site cations 30 are 12 and 6, respectively. In other words, as shown in the lower representation of FIG. 5, the perovskite crystal 10 can be seen as a three-dimensional network of corner-sharing of oxygen octahedra BO₆. The perovskite crystal 10 does not need to be perfectly cubic, and indeed, many ABO₃-formula compounds are off the ideal cubic structure and distorted to a lower symmetry. More specifically, the ferroelectricity in the perovskite is because of i) relative cation displacement and ii) BO₆ octahedra tilting. Oxygen octahedra have three 4-fold axes, four 3-fold axes, and six 2-fold axes.

In conventional PbZrO₃ materials, a single crystal material provides better properties than polycrystalline materials. In particular, polycrystalline PbZrO₃ ceramic at room temperature has a critical field for the phase transition, E_{F}, that exceeds the breakdown strength of the ceramic. However, the synthesis of PbZrO₃ single crystal is much pricier and more challenging, and because of the high phase transition field, the merits of pure polycrystalline PbZrO₃ have not been fully exploited. Thus, PbZrO₃-based oxides are modified for practical utilization. Such modifications include doping the PbZrO₃ crystal with various dopants to decrease the phase transition field, boost the polarization, and lower the sintering temperature, among other property enhancements.

According to the present disclosure, one strategy is doping of the A-site cations 20 with, for example, Li⁺, Bi³⁺, La³⁺, Ba²⁺, and Sr²⁺. Another strategy is to substitute B-site cations 30 with, for example, Ti⁴⁺, Sn⁴⁺, and Nb⁵⁺. Multiple A-site cation 20 and B-site cation 30 dopants can be used to tune the electric and dielectric properties as needed for a particular application. The addition of such dopants directly influences the tolerance factor, which affects antiferroelectricity (i.e., E_{F}, E_{A}, electric hysteresis, and energy storage properties). The dopant Sr²⁺ is effective in reducing the hysteresis and producing a higher transition field. The dopant La³⁺ produces A-site vacancies to preserve charge neutrality. Low La³⁺ doping concentration (usually less than 3 mol %) increases the antiferroelectric-to-ferroelectric transition field, and the inventors expect that a higher concentration may lead to a relaxor behavior.

The disclosed AFE oxide has the general formula of:

[Pb_{1-x-y-z-1.5w}(Li_{1/2}Bi_{1/2})ₓSr_{y}Ba_{z}La_{w}](Zr₁₋ᵤ₋ᵥSnᵤTiᵥ)O₃ (1)

Thus, the base PbZrO₃ crystal may be doped with Sr²⁺, Ba²⁺, La³⁺ for the A-site cations 20, and B-site cation 30 dopants include Sn⁴⁺ and Ti⁴⁺. According to the present disclosure, the advantages of increased dielectric breakdown strength, increased energy efficiency, and decreased sintering temperature result from the inclusion of Li⁺ and Bi³⁺ ions as A-site substitutions in the perovskite crystal structure.

In one or more embodiments, x (Li⁺ and Bi³⁺) is in a range from 0.01 to 0.16, in particular from 0.04 to 0.12). In one or more embodiments, the atomic ratio of Li⁺ and Bi³⁺ is about 1:1. In one or more embodiments, y (Sr²⁺) is in a range from 0 to 0.10, in particular in a range from 0.03 to 0.06. In one or more embodiments, z (Ba²⁺) is in a range from 0 to 0.10, in particular in a range from 0.03 to 0.06. In one or more embodiments, w (La³⁺) is in a range from 0 to 0.05, in particular in 0.02 to 0.03. In one or more embodiments, u (Sn²⁺) is in a range from 0 to 0.50, in particular 0.30 to 0.45. In one or more embodiments, v (Ti⁴⁺) is in a range from 0 to 0.12, in particular from 0.05 to 0.10.

According to the embodiments of the present disclosure, the PbZrO₃-based AFE material can be prepared by substituting lead oxide (PbO) with lithium oxide (Li₂O) and/or lithium carbonate (Li₂CO₃) and bismuth oxide (Bi₂O₃) during sintering.

### Experimental Example 1

(Li_{1/2}Bi_{1,2})O was substituted for PbO in the formation of PbZrO₃-rich AFE compositions starting with the base composition of (Pb_{0.93}Sr_{0.04}La_{0.02})(Zr_{0.57}Sn_{0.34}Ti_{0.09})O₃. In particular, substitutions were made according to the formula:

[Pb_{0.93-x}(Li_{1/2}Bi_{1/2})ₓSr_{0.04}La_{0.02})](Zr_{0.57}Sn_{0.34}Ti_{0.09})O₃ (2)

in which x was 0.04, 0.08, 0.12, and 0.16.

To prepare the AFE base compositions, high-purity raw powders (>99.9%) of PbO, La₂O₃, Li₂CO₃, Bi₂O₃, SrCO₃, ZrO₂, SnO₂, TiO₂ were baked first to remove the moisture. Because PbO evaporates during high temperature processing, an extra 5 wt % PbO was added to preserve the designed stoichiometry. The dry powder was batched according to chemical formula (2) and mixed in a vibratory mill for 6 hours with zirconia media in ethanol. The mixed slurry was dried for 24 hours, and then the powder was calcined at 935° C. for 4 hours. The calcined powder was re-milled for another 6 hours and dried for 24 hours. The dry powder was mixed with 10 wt % polyvinyl alcohol binder and uniaxially pressed into green pellets at a pressure of 150 MPa. The pellets were de-bindered at 600° C. for 3 hours and then sintered at temperatures in the range of 1075-1350° C. During sintering, the pellets were buried in the calcined powder of the same composition, and a double crucible setup was applied to further minimize the PbO evaporation loss.

X-ray diffraction (XRD) was performed to examine the crystal structure and phase purity of the sintered ceramics on a Siemens D500 X-ray diffractometer using a Cu-Kα radiation in a 2θ range from 20° to 80°. The fracture surfaces of the ceramics were examined with FEI Inspect 50 scanning electron microscope (SEM) to reveal the grain morphology and size. The grain size was quantified using the line intercept method.

To characterize the dielectric and ferroelectric properties, ceramic pellets were polished to a thickness of about 0.25 mm and electroded with a Pd-target sputter coater. The polarization vs. electric field loops were measured at room temperature at a frequency of 1 Hz using a standardized ferroelectric test system (Precision LC II, Radiant Technologies). The dielectric property of the AFE ceramic material was measured using a Novocontrol system at a heating rate of 1° C./min at 1 KHz frequency.

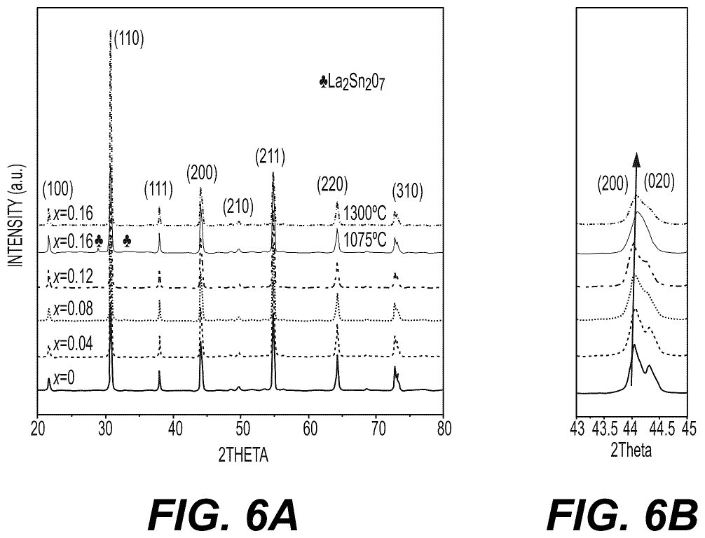

Sintered ceramic pellets of all compositions exhibit a relative density of greater than 95%. To achieve the same relative density, the sintering temperature was almost linearly reduced from 1350° C. for the base composition (x=0) to 1075° C. for the composition of x=0.16. The main phase of all compositions was determined to be perovskite, and for the high-dopant composition x=0.16, a second phase, La₂Sn₂O₇, was observed. La₂Sn₂O₇ might be an intermediate phase during the formation of the final perovskite phase, and the lower sintering temperature of 1075° C. is not high enough to achieve the full reaction. As a comparison experiment, x=0.16 was also sintered at a high temperature (1300° C.), and XRD was performed. At the higher sintering temperature, the La₂Sn₂O₇ phase disappeared. FIG. 6A depicts the XRD pattern for the base composition (x=0) and for the compositions x=0.04, 0.08, 0.12, and 0.16 (including the higher sintering temperature sample). FIG. 6B provides a detail view of the pattern from 43° to 45°, where the (200)/(020) split peaks shift to the high angle region.

The radii of all A-site substitutions [Sr²⁺ (1.44 Å), Bi³⁺ (1.35 Å), Li⁺ (0.92 Å), and La³⁺ (1.36 Å)] are smaller than that of Pb²⁺ (1.49 Å). Further, the radii of the B-site substitutions [Sn⁴⁺ (0.69 Å) and Ti⁴⁺ (0.605 Å)] are smaller than that of Zr⁴⁺ (0.72 Å). The incorporated smaller ions lead to a decrease in the interplanar spacings because of the more compact unit cell, which results in the XRD peaks shifting to high 2θ angles. The peak shift is accompanied with the double-peak merging, which is a sign of the reduction of tetragonality, and the crystal structure gradually transforms into the cubic phase with the increase of the (Li,Bi)-co-doping amount. Interestingly, the splitting of (200)/(020) peak of the composition x=0.16 does not occur at low sintering temperature but can be resolved when sintered at 1300° C., which is a sign of weaker tetragonal distortion in the pellet sintered at 1075° C.

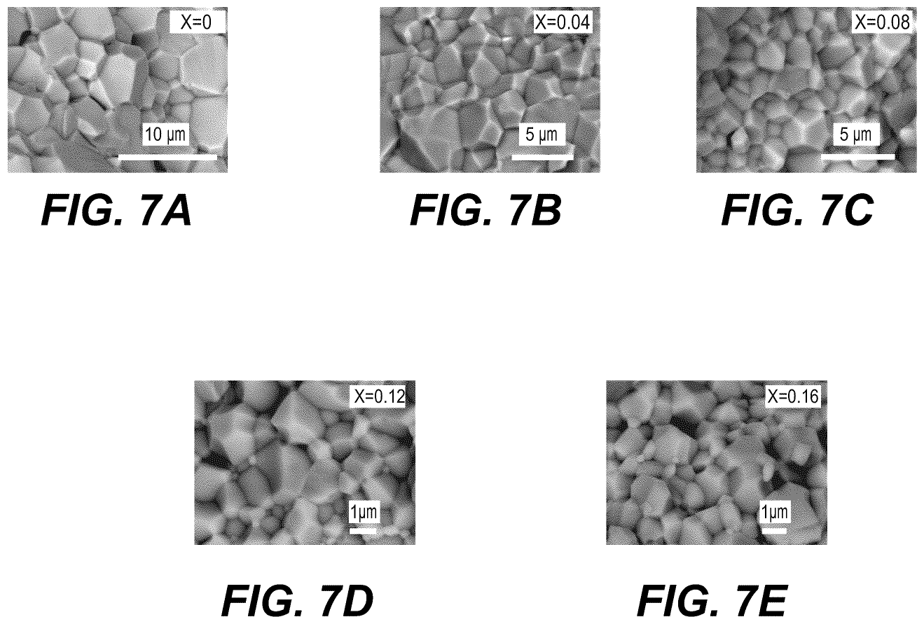

FIGS. 7A-7E shows the most representative SEM micrographs of the fracture surface of the as-sintered PL(Li,Bi)SrZST 2/100x/4/34/9 series. The grain size was determined via the line intercept method with over 300 grains measured for each composition. With the increase of (Li,Bi)-co-doping, the grain size reduces significantly. The grain size of x=0 base composition was 4.98 μm (FIG. 7A), and the grain size of the x=0.16 composition was reduced to 1.19 μm (FIG. 7E). At the low doping range (x<0.12) shown in FIGS. 7B and 7C, the grains display a strong faceting feature, but when x is larger than 0.08 as shown in FIGS. 7D and 7E, some small “spherical” particles can be observed embedded among the large, faceted grains. Per XRD results, in x=0.12, the phase was pure perovskite, so these small particles were likely incompletely grown grains because of the decreased sintering temperature resulting from the introduction of Bi³⁺ and Li⁺ doping. In the high doping composition x=0.16, elliptic particles appeared. According to XRD analysis, those particles were very likely the second phase La₂Sn₂O₇.

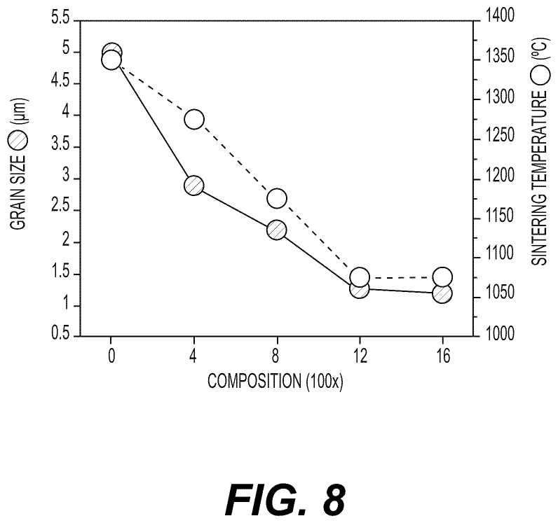

The detailed values for the grain size and sintering temperature are provided in Table 1 and graphed in FIG. 8.

TABLE 1
Electrical properties of PbZrO₃-based AFE ceramic according to Formula 2

| | Sintering | Grain | Drive | | | Dielectric | | |
|---|---|---|---|---|---|---|---|---|
| | Temp. | Size | field | W_{rec} | η | constant | Loss tangent | Tₘ |
| x | (° C.) | (μm) | (kV/cm) | (J/cm³) | (%) | (at 25° C.) | (at 25° C.) | (° C.) |
| 0.00 | 1350 | 4.98 | 160 | 3.56 | 90.3 | 736 | 0.005 | 153 |
| 0.04 | 1275 | 2.89 | 150 | 3.42 | 92.6 | 639 | 0.006 | 149 |
| 0.08 | 1175 | 2.19 | 180 | 3.23 | 90.4 | 668 | 0.007 | 143 |
| 0.12 | 1075 | 1.27 | 200 | 3.22 | 94 | 729 | 0.010 | 140 |
| 0.16 | 1075 | 1.19 | 180 | 2.58 | 90 | 711 | 0.024 | 142 |

As mentioned above, the grain size and sintering temperature decreased almost linearly with increasing (Li_{1/2}B_{1/2})O content. In particular, the average grain size was 3 μm or less for each of the compositions including 4 at % of (Li_{1/2}B_{1/2})O or more, and the sintering temperature decreased to 1300° C. or less, including 1100° C. or less at 12 at % and higher.

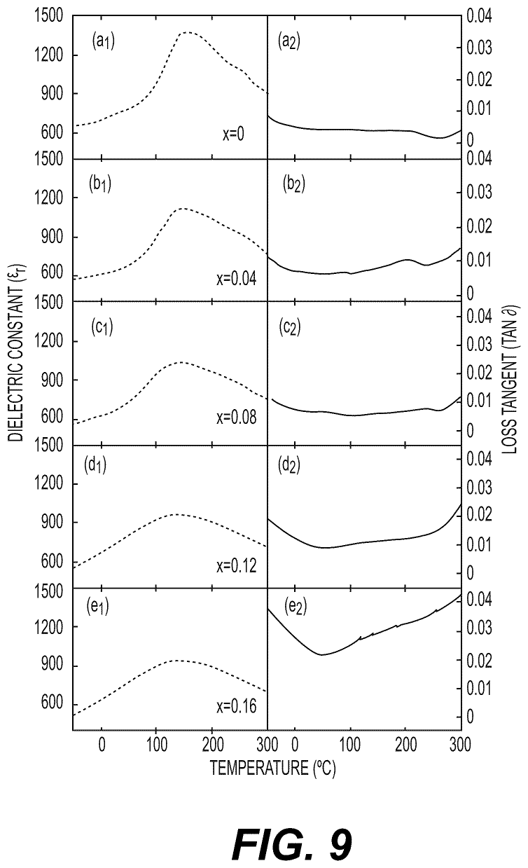

The dielectric constant and loss tangent of the modified AFE ceramic materials were measured and are provided in Table 1 (at 25° C.) and are graphed in FIG. 9 (over the temperature range of −50° C. to 300° C.). As can be seen, the addition of the (Li_{1/2}Bi_{1/2})O chemical modifier decreases moderately the dielectric constant at room temperature (e.g., from 736 in x=0 to 640 in x=0.04), increases marginally the loss tangent at room temperature (e.g., from 0.005 in x=0 to 0.006 in x=0.04), and reduces slightly the dielectric peak temperature Tₘ (e.g., from 153° C. in x=0 to 149° C. in x=0.04). Accordingly, the disclosed (Li,Bi)-modified PbZrO₃ ceramic remains suitable as a ceramic material for capacitors.

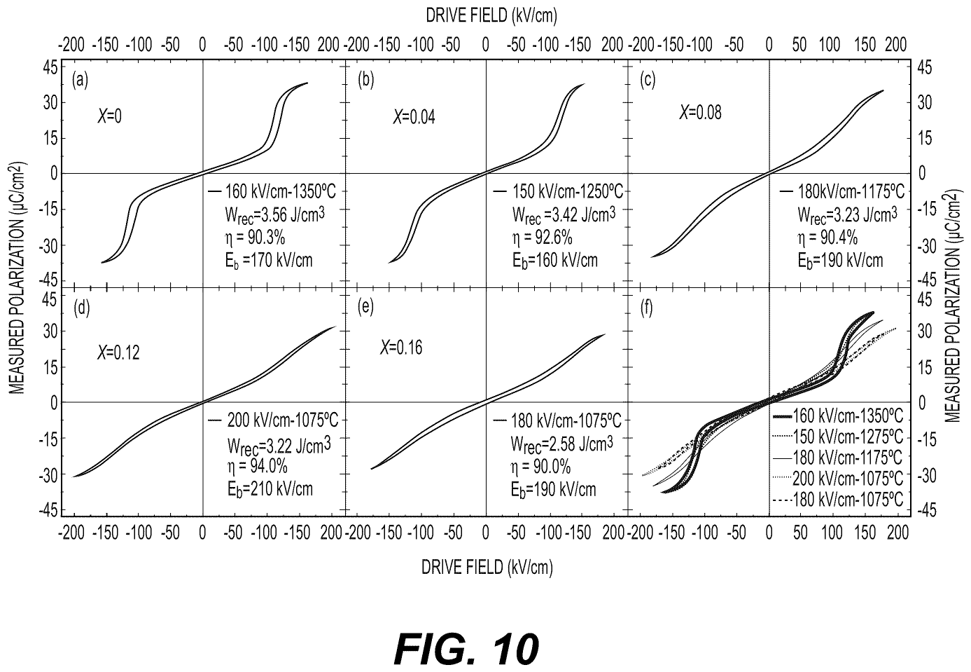

FIG. 10 provides polarization vs. electric field plots (P-E loops) for the various compositions of the (Li,Bi)-modified PbZrO₃ antiferroelectric material having from 0 at % (Li_{1/2}Bi_{1/2})O to 16 at %. The energy efficiencies of all the compositions were above 90% and, for x≤0.12, the energy densities were all higher than 3.2 J/cm³. With the increase of the (Li,Bi)-co-doping amount, the loops evolve into slimmer shapes until the appearance of the second phase at high doping amount x=0.16. The composition of x=0.12 was observed to achieve excellent performance with a high recoverable energy density of 3.22 J/cm³, an ultrahigh energy efficiency of 94.0%, and a high breakdown strength of 210 kV/cm.

All P-E loops were replotted in in graph (f) of FIG. 10 to provide a direct comparison. From the overlaid P-E loops, it can be seen that the critical field decreases with the increasing amount of (Li,Bi)-dopant, and the electric hysteresis drops significantly as well, which confirms the enhanced relaxor characteristics. From the P-E loops of FIG. 10, the remnant polarization could also be determined as the average of the positive and negative P-axis intercepts. The remnant polarization values of all compositions were smaller than 1 μC/cm².

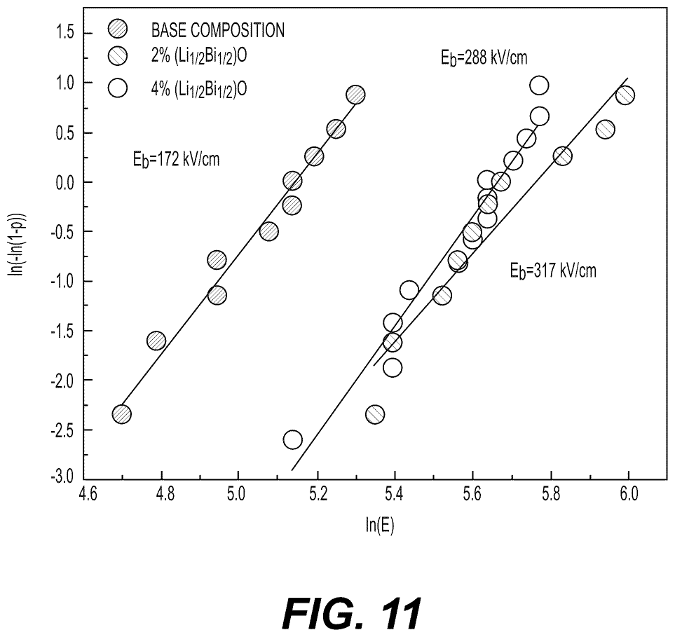

FIG. 11 provides a Weibull plot for dielectric breakdown strength for a base composition (no Li or Bi doping) and for compositions containing 2 at % (Li,Bi)-doping and 4 at % (Li,Bi)-doping. As can be seen, the dielectric breakdown strength increases significantly with even low levels of (Li,Bi)-doping. In particular, the base composition (sintered at 1350° C.) exhibited a breakdown strength of 172 kV/cm. The 2 at % doped composition exhibited a dielectric breakdown strength of 317 kV/cm (84.3% improvement), and the 4 at % doped composition exhibited a dielectric breakdown strength of 288 kV/cm (67.4% improvement). Advantageously, both of the doped compositions were sintered at a much lower temperature of 1075° C.

### Experimental Example 2

(Li_{1/2}Bi_{1/2})O was substituted for PbO in the formation of PbZrO₃-rich AFE compositions starting with the base composition of (Pb_{0.87}Ba_{0.05}Sr_{0.05}La_{0.02})(Zr_{0.52}Sn_{0.40}Ti_{0.08})O₃. In particular, substitutions were made according to the formula:

[Pb_{0.87-x}(Li_{1/2}Bi_{1/2})ₓBa_{0.05}Sr_{0.05}La_{0.02})](Zr_{0.52}Sn_{0.40}Ti_{0.08})O₃ (3)

in which x was 0.04, 0.06, and 0.08.

The samples of the AFE ceramic material prepared according to Equation 3 were sintered for 3 hours at 1050° C., which is about 300° C. less than the sintering temperature of a conventional PbZrO₃-based ceramic material.

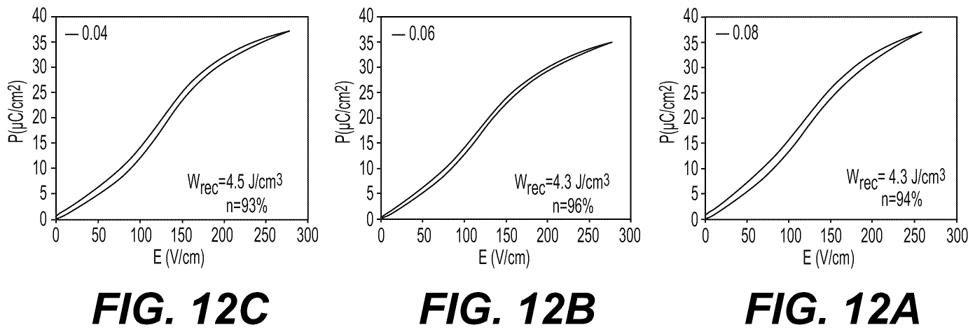

FIGS. 12A-12C provide P-E loops for the three compositions prepared according to Equation 3. The energy density W_{rec} for all three samples was over 4 J/cm³. In particular, the sample in which x (Li_{1/2}Bi_{1/2}) was 0.04 had an energy density as high as 4.5 J/cm³ as shown in FIG. 12A. For both of the other samples (x=0.06 and 0.08), the energy density W_{rec} was 4.3 J/cm³ as shown in FIGS. 12B and 12C, respectively. Each of the energy efficiencies (η) was over 90%. In particular, the energy efficiency for the sample x=0.06 (FIG. 12B) was as high as 96%. For the sample x=0.08 (FIG. 12C), the energy efficiency was 94%, and for the sample x=0.04 (FIG. 12A), the energy efficiency was 93%.

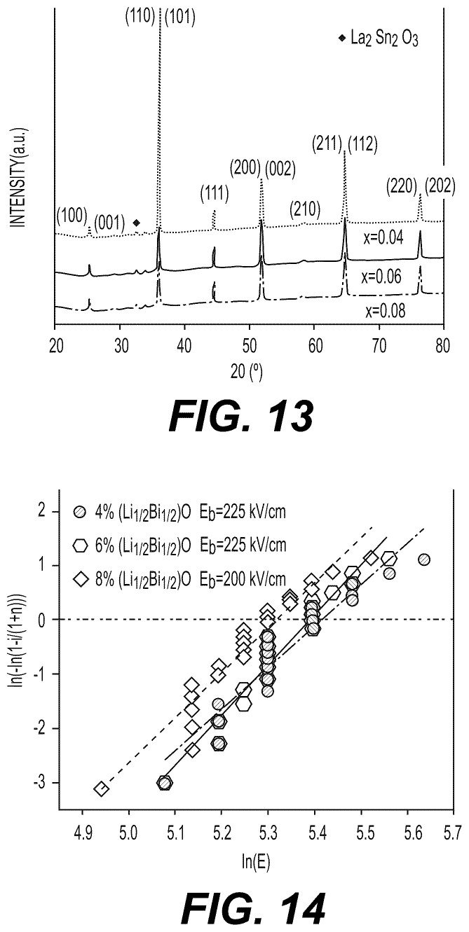

The phase purity of the AFE ceramic samples prepared according to Equation 3 was confirmed by XRD spectra as shown in FIG. 13. In particular, the XRD spectra of FIG. 13 confirm that there was minimal presence of secondary phases, such as La₂Sn₂O₇.

The dielectric breakdown strength was measured on multiple samples of each composition and analyzed using Weibull statistics as shown in FIG. 14. As can be seen, the addition of the (Li_{1/2}Bi_{1/2})O chemical modifier was confirmed to improve the breakdown strength, especially at the concentrations of x=0.04 and 0.06. Compared to the base composition (with a breakdown strength similar to that shown in FIG. 11), these two compositions exhibit a 31% improvement in breakdown strength (up to 225 kV/cm).

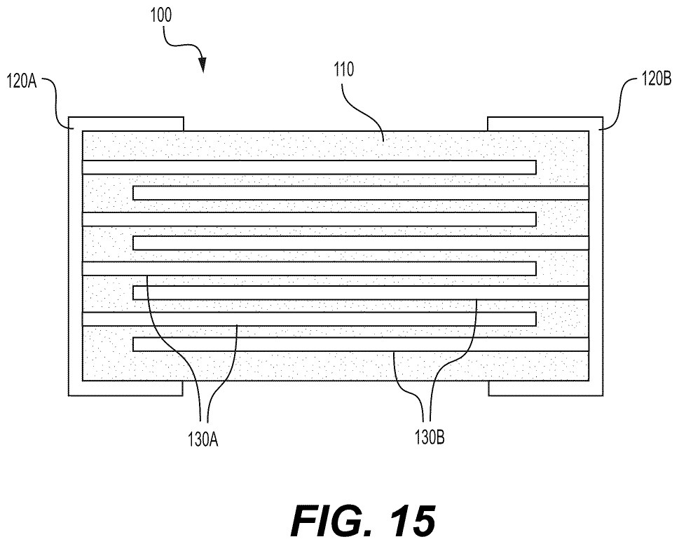

As discussed above, the disclosed AFE ceramic material is particularly suitable for use in capacitors, such as the capacitor 100 shown in FIG. 15. FIG. 15 depicts a multilayer ceramic capacitor 100 having layers of AFE ceramic material 110 disposed between a first end electrode 120a and a second end electrode 120b. Disposed between the layers of AFE ceramic material 110 are first internal electrodes 130a and second internal electrodes 130b. The first internal electrodes 130a are in electrical communication with the first end electrode 120a, and the second internal electrodes 130b are in electrical communication with the second end electrode 120b.

Advantageously, a capacitor 100 made from the AFE ceramic material 110 provides a fast discharge rate (<1 μs), making the capacitor 100 particularly suitable for systems requiring high-frequency (1˜100 kHz) power conditioning and fast-discharge pulse power. With the fast growth of clean energy from renewable sources, where power inverters (DC to AC) are important to connecting electricity to a regional grid, and millions of electric cars projected for production, where power conditioning is key to energy efficiency, the disclosed AFE ceramic material is expected to satisfy the urgent demand for reliable capacitors having a large energy density while maintaining the desired level of power density.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An antiferroelectric material, comprising:
a PbZrO₃-based ceramic, wherein at least 1 at % and up to 16 at % of Pb is substituted with a combination of Li and Bi.

2. The antiferroelectric material of claim 1, wherein a ratio of Li to Bi is about 1:1.

3. The antiferroelectric material of claim 1, comprising an energy density of at least 3.0 J/cm².

4. The antiferroelectric material of claim 1, comprising an energy efficiency of at least 90%.

5. The antiferroelectric material of claim 1, having a general formula of [Pb_{1-x-y-z-1.5w}(Li_{1/2}Bi_{1/2})ₓSr_{y}Ba_{z}La_{w}](Zr₁₋ᵤ₋ᵥSnᵤTiᵥ)O₃.

6. The antiferroelectric material of claim 5, wherein 0.01≤x≤0.12.

7. The antiferroelectric material of claim 5, wherein 1-x-y-z-1.5w≥0.85

8. The antiferroelectric material of claim 5, wherein 1-u-v≥0.50.

9. The antiferroelectric material of claim 5, wherein v≤0.12.

10. The antiferroelectric material of claim 1, comprising an average grain size of 3 μm or less.

11. The antiferroelectric material of claim 1, comprising a dielectric breakdown strength of 180 kV/cm or higher.

12. The antiferroelectric material of claim 1, wherein a temperature at which a maximum dielectric constant is reached is at least 140° C.

13. A capacitor comprising the antiferroelectric material according to claim 1.

14. The capacitor of claim 13, wherein the capacitor is a multilayer ceramic capacitor.

15. A method of preparing an antiferroelectric material comprising a PbZrO₃-based ceramic in which at least 1 at % and up to 16 at % of Pb is substituted with Li and Bi, the method comprising:
mixing a plurality of powdered raw materials, the plurality of powdered raw materials comprising cations of lead, zirconium, lithium, and bismuth;
sintering the plurality of powdered raw materials at a temperature of 1300° C. or less to form the antiferroelectric material.

16. The method of claim 15, wherein mixing further comprises mixing the plurality of powdered ceramics with a binder, wherein the method further comprises:
pressing the plurality of powdered raw materials into a green body; and
heating the green body to a temperature sufficient to burn off the binder; and
wherein sintering further comprises sintering the plurality of powdered ceramics in the green body.

17. The method of claim 15, wherein the plurality of powdered raw materials comprises PbO, Li₂CO₃, Bi₂O₃, ZrO₂, and at least two of La₂O₃, SrCO₃, SnO₂, or BaO.

18. The method of claim 17, wherein excess PbO powder is provided to account for evaporation during sintering.

19. The method of claim 15, wherein the antiferroelectric material comprises a density of at least 95% after sintering.

20. The method of claim 15, wherein the temperature during sintering is 1100° C. or less.
